(19) United States
(12) Patent Application Publication
(10) Pub. No.: US 2025/0334930 A1
(43) Pub. Date: Oct. 30, 2025

(54) FLUID-BASED GAME TIMER SYSTEM

(71) Applicant: Raymond Aldridge, San Francisco, CA (US)

(72) Inventor: Raymond Aldridge, San Francisco, CA (US)

(21) Appl. No.: 18/646,038

(22) Filed: Apr. 25, 2024

(51) Int. Cl. G04F 13/06; A63F 11/00; B67D 1/00

(52) U.S. Cl. CPC G04F 13/06; A63F 11/0051; B67D 1/0006; B67D 1/0082; A63F 2250/024; A63F 2250/04; A63F 2250/1073

(57) ABSTRACT

A fluid-based game timer system for use with turn-based games. The fluid-based game timer system includes a reservoir for holding a volume of fluid (such as beer), a constant flow tank to regulate the flow of the fluid through the system and to keep the flow constant or near constant, and a control assembly to direct the flow of the fluid into a particular player's cup during his/her turn.

### FIELD OF THE INVENTION

This invention relates to game timer devices, including a fluid-based game timer system for use with turn-based games.

### BACKGROUND

Turn-based games require players to take turns, with each player's turn often timed to keep the game moving at a steady pace. However, existing timing mechanisms (such as hourglass timers, dial alarms, etc.) lack an engaging and dynamic element, and do not directly relate the length of a player's turn to a tangible consequence in the game setting.

There is therefore a need for a timing device that can add an additional layer of challenge and strategy to turn-based games. There also is a need for a fluid-based game timer system.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIG. 1 shows a block diagram of a fluid-based game timer system in accordance with exemplary embodiments hereof;

FIG. 2 shows aspects of a fluid-based game timer system in accordance with exemplary embodiments hereof;

FIGS. 3-5 show aspects of a constant flow rate assembly in accordance with exemplary embodiments hereof;

FIG. 6 shows aspects of a valve member in accordance with exemplary embodiments hereof;

FIGS. 7-8 show aspects of a valve member configured with a constant flow rate assembly in accordance with exemplary embodiments hereof;

FIG. 9 shows aspects of a fluid director in accordance with exemplary embodiments hereof;

FIG. 10 shows aspects of a fluid conduit assembly in accordance with exemplary embodiments hereof;

FIG. 11 shows aspects of a fluid-based game timer system in accordance with exemplary embodiments hereof;

FIG. 12 shows aspects of a control assembly in accordance with exemplary embodiments hereof; and

FIG. 13 shows aspects of a fluid-based game timer system in accordance with exemplary embodiments hereof.

### DETAILED DESCRIPTION OF EXEMPLARY EMBODIMENTS

In general, the system and method according to exemplary embodiments hereof includes a fluid-based game timer system for use with turn-based games. In general, the system serves to track the length of a player's turn and to provide a fluid reward (or penalty) based on the duration of the turn. In use, the system may be triggered to begin a flow of a fluid (e.g., a beverage such as beer) into a particular player's cup at the onset of the same player's turn. As the player's turn continues, the beverage continues to flow. The longer the player's turn, the more fluid accumulates in their cup. At the end of the player's turn, the player may be required to consume the accumulated beverage adding a fun entertaining element to the game. The fluid-based game timer system may be used with any turn-based game, such as chess, checkers, card games, puzzle games, and other types of games.

In addition, the fluid-based game timer system may be designed to provide a constant flow rate of the fluid into each of the player's cups, thereby providing a constant time tracking and fluid providing utility to each of the players regardless of the level of fluid stored within the system.

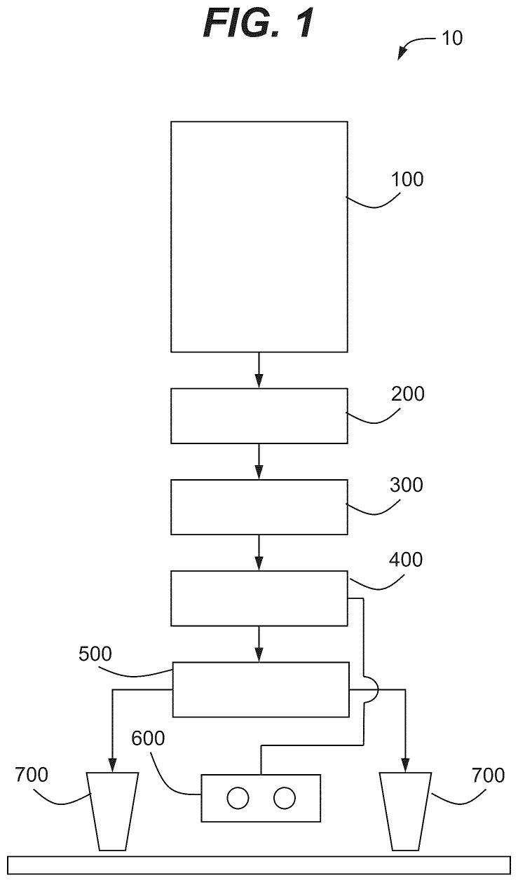

FIG. 1 shows a block diagram of a fluid-based timing system 10 according to exemplary embodiments.

In some embodiments, as shown in FIG. 1, the fluid-based game timer system 10 (also referred to herein as simply the system 10) includes a reservoir assembly 100, a constant flow rate assembly 200, a valve assembly 300, a fluid path control assembly 400, a fluid conduit assembly 500, a control assembly 600, and one or more containers 700 (e.g., player cups). The system 10 also may include a housing 800. In general, the reservoir assembly 100 holds a volume of a fluid (e.g., a beverage) for use during the game play, the constant flow rate assembly 200 affects the fluid flow rate passing through the system 10 such that the flow rate is substantially constant, the valve assembly 300 sets the level of the flow rate, the fluid path control assembly 400 sets a path of the fluid, the fluid conduit assembly 500 provides one or more pathways for the fluid to flow, the control assembly 600 controls the fluid path control assembly 400, and the containers 700 (e.g., cups) receive the fluid during game play. The system 10 also may include other aspects and/or elements to fulfill its functionalities.

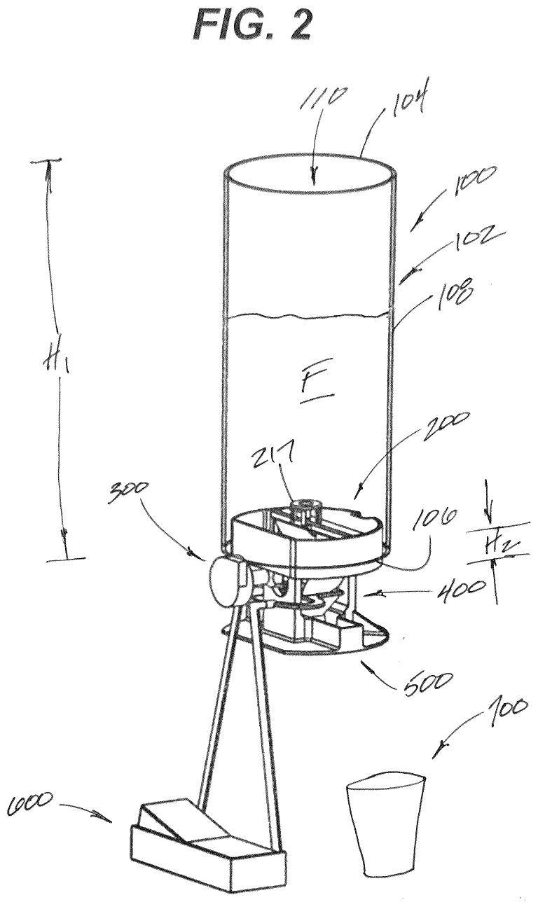

In some embodiments, as shown in FIG. 2, the reservoir assembly 100 may include a tank 102 including a top side 104, a bottom side 106, sidewalls 108 extending between the top side 104 and the bottom side 106, all of which define the reservoir's inner volume 110. In general, the reservoir 100 is filled at least partially with a fluid F (e.g., through an open top side 104) such that the fluid F may be controlled to flow out of the tank 102 (e.g., through a port configured with the bottom side 106). While the reservoir assembly 100 is depicted in FIG. 2 generally as a hollow cylindrical container, it is understood that the reservoir assembly 100 may include any suitable shape or form. In addition, it may be preferable for the tank sidewalls 108 to be transparent or semitransparent such that players may view the level of the fluid F therein. This may add an entertainment value to the game as the fluid level within the tank 102 may drop for all to see during a player's turn.

As is known in fluid dynamics, the velocity of a fluid F in the reservoir tank 102 out a fluid port in its bottom side 106 will depend on the fluid pressure at the fluid port. In addition, the fluid pressure at the fluid port will depend on the level of the fluid F within the tank 102. That is, when the fluid level is high (e.g., near or at the top 104 of the tank 102) the fluid pressure will be higher and the flow rate through the bottom fluid port will therefore be faster. However, when the fluid level is lower (e.g., at or below the midpoint of the tank 102), the fluid pressure at the bottom fluid port will be lower resulting in a slower flow rate through the fluid port.

Accordingly, during game play, if the reservoir tank 102 is first filled with a fluid F, the velocity of the fluid F passing through a fluid port on the bottom 106 of the tank 102 will begin at a higher flow rate that decreases as the level of the fluid F in the tank 102 diminishes. However, it may be preferable for the system 10 to provide a constant (or near constant) flow rate through the system 10 regardless of the fluid level within the tank 102 such that each player may receive the same (or similar) amount of fluid in his/her cup over a similar amount of time (e.g., during his/her turn).

Given the above, the system's constant flow rate assembly 200 may be designed to receive fluid F from the reservoir tank 102 and to then provide the fluid F to the rest of the system 10, and ultimately to the player's cups 700, at a constant flow rate.

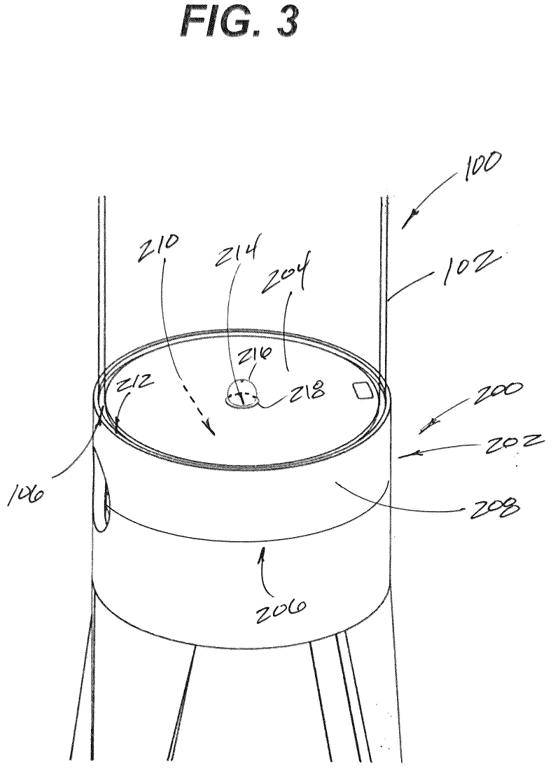

FIG. 3 shows the bottom side 106 of the reservoir's tank 102 configured with the constant flow rate assembly 200.

In some embodiments, as shown in FIG. 3, the bottom side 106 of the tank 102 is configured with the constant flow rate assembly 200 such that fluid F within the tank 102 may be controlled to flow into the constant flow rate assembly 200 during use. This connection is preferably fluid tight. The constant flow rate assembly 200 may moderate the flow of the fluid F through the system 10.

In some embodiments, the constant flow rate assembly 200 includes a constant flow rate tank 202 including a tank top side 204, a tank bottom side 206, tank sidewalls 208 extending between the tank top side 204 and the tank bottom side 206, all of which define a tank inner volume 110.

In some embodiments, as shown in FIG. 3, the tank top side 204 may include an outer circumferential slot 212 designed and sized to receive the bottom side 106 of the reservoir assembly 100. In this way, the reservoir assembly 100 may be configured with the constant flow rate assembly 200. A gasket or O-ring may be positioned within the circumferential slot 212 to provide a fluid-tight seal. It is understood that the bottom side 106 of the reservoir assembly 100 may be coupled to the top side 204 of the tank 202 using other suitable and preferably fluid-tight configurations and/or arrangements.

In some embodiments, as shown in FIG. 3, the top side 204 of the constant flow rate tank 202 includes a fluid port 214 (e.g., a hole) through which the fluid F from the reservoir tank 102 may flow into the constant flow tank 202.

In some embodiments, a port regulator 216 (e.g., a ball or marble) may be configured with (e.g., may rest on) the fluid port 214 and may be used to regulate the fluid F passing through the port 214. It may be preferable that the port regulator 216 have a diameter that is slightly greater than the diameter of the fluid port 214 such that the regulator 216 may completely cover the port 214 when resting thereupon and block fluid F from passing through the port 214 until desired. In some embodiments, the fluid port 214 may include a circumferential gasket 218 upon which the regulator 216 may rest thereby providing a fluid-tight interface between the regulator 216 and the port 214.

In some embodiments, the port regulator 216 (e.g., the marble) may be controllably displaced, e.g., moved off of the fluid port 214, to allow fluid F to flow through the port 214 and into the constant flow rate tank 202.

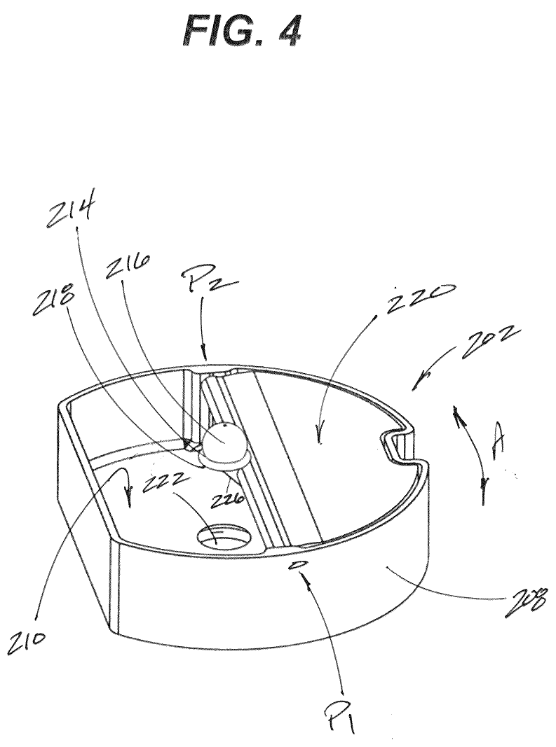

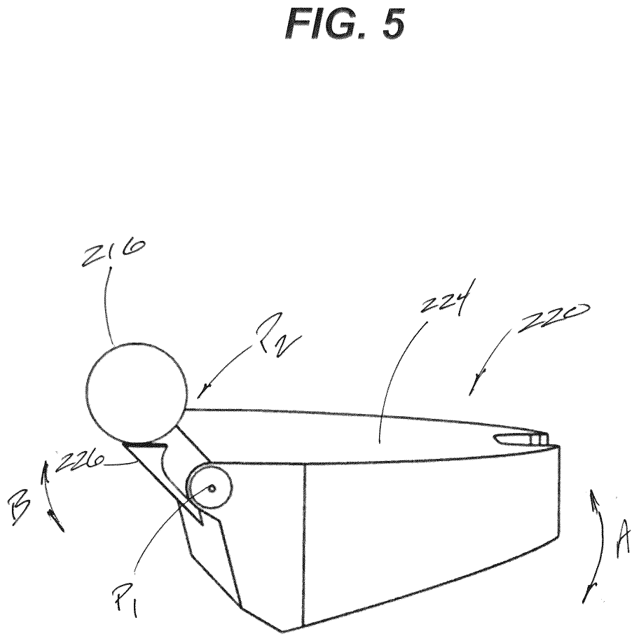

FIG. 4 shows the constant flow rate tank 202 isolated with its top 204 made transparent for clarity, and including the port regulator 216 (e.g., the marble) and the marble's gasket 218 configured with the fluid port 214. FIG. 5 shows the constant flow tank's floater mechanism 220 isolated and including the port regulator 216 (e.g., the marble).

In some embodiments, as shown in FIG. 4, the constant flow tank 202 includes a floater mechanism 220 configured to displace the port regulator 216 (e.g., the marble) when it is desired to allow fluid F to flow from the reservoir tank 102 into the constant flow tank 202 through the fluid port 214.

In addition, the constant flow tank 202 also may include a lower fluid output port 222 that allows fluid F from within the constant flow tank 202 to be delivered to the rest of the system 10. As will be described herein, the flow rate out of the constant flow rate tank's lower fluid output port 222 is preferably constant or near constant.

In some embodiments, as shown in FIGS. 4 and 5, the floater mechanism 220 includes a floater body 224 shaped to fit within a portion of the tank's inner volume 210 (e.g., as a semicircle that takes up about half the cross-sectional area of the tank 202) and pivotably configured with the sides 208 of the tank 202 at pivot points P1 and P2. In this way, the floater mechanism 220 may rotate upward and/or downward about the pivot points P1, P2 as indicated by the arrow A.

In some embodiments, the floater body 224 comprises a weight to volume ratio that makes it slightly lighter than the fluid F (e.g., slightly lighter than the fluid F and/or than water for example), thereby providing a proper buoyancy such that the floater body 224 may rotate about the pivot points P1, P2 to generally follow the surface level of the fluid F within the constant flow rate tank 202. Notably, FIG. 4 depicts the floater mechanism 220 in its generally upper position when the constant flow rate tank 202 is generally filled with fluid F. Conversely, when the fluid level within the constant flow tank 202 drops, the floater body 224 may follow the fluid surface level and rotate downward about the pivot points P1, P2.

In some embodiments, as best seen in FIG. 5, the floater mechanism 220 includes a displacement tab 226 configured to displace the port regulator 216 to allow fluid F to flow from the reservoir tank 102 through the fluid port 214 and into the constant flow rate tank 202. In some embodiments, the displacement tab 226 is coupled to the floater body 224 and may be caused to move upward and/or downward as indicated by the arrow B when the floater body 224 moves downward and/or upward, respectively, about the pivot points P1, P2. In some embodiments, the displacement tab 226 may be generally located between the pivot points P1, P2 and may extend outward from the floater body 224 therefrom.

In some embodiments, a distal end of the displacement tab 226 may be positioned beneath the port regulator 216 (e.g., may abut against the bottom of the marble) such that when the displacement tab 226 is caused to move upward, the tab 226 may press upward against the regulator 216. This may displace the regulator 216 and open the fluid port 214. As such, when the fluid level within the constant flow tank 202 drops and the floater body 224 pivots downward, the displacement tab 226 is caused to pivot upward thereby displacing the port regulator 216 (e.g., pushing it upward) and opening the fluid port 214. Fluid F from the reservoir tank 102 may then flow into the constant flow tank 202. The regulator 216 also may include a cage 217 (best seen in FIG. 2) that rests over the regulator 216 (e.g., over the marble) and that provides freedom to the regulator 216 to move upward vertically while limiting the marble's lateral movement during its generally vertical displacement. In this way, the marble 216 may be prevented from falling to the side.

Conversely, as fluid F flows from the reservoir tank 102 into the constant flow tank 202 such that the fluid level within the tank 202 rises, the floater body 224 may rotate upward (following the rising fluid level within the constant flow tank 202), and the displacement tab 226 may be caused to move downward. This may place the port regulator 216 (e.g., the marble) back onto the fluid port 214 thereby closing the port 214 and disallowing any further fluid F to flow into the constant flow tank 202.

In some embodiments, the reservoir tank 102 may include a height H1 and the constant flow rate tank 202 may include a height H2. In some embodiments, it may be preferable that the height H2 of the constant flow tank 202 be chosen to be substantially less than the height H1 of the reservoir tank 102.

For example, in some embodiments, the height of the height H2 of the constant flow tank 202 be chosen to be about 1%-20% the height H1 of the reservoir tank 102, and preferably about 2%-15% the height H1 of the reservoir tank 102, and more preferably about 5%-10% the height H1 of the reservoir tank 102, and more preferably about 8% the height H1 of the reservoir tank 102. In some embodiments, the height H1 of the reservoir tank 102 may be about 100 mm to about 400 mm, and preferably about 150 mm to about 350 mm, and more preferably about 200 mm to about 325 mm, and more preferably about 250 mm to about 300 mm, and more preferably about 280 mm. In some embodiments, the height H2 of the constant flow tank 202 may be about 23 mm.

With the height H2 of the constant flow tank 202 chosen to be small, the flow rate out of the constant flow tank's lower fluid port 222 may not vary substantially whether the fluid level within the constant flow tank 202 is high or it is low as the difference in the fluid pressure between the high and low levels may not cause a significant change in the fluid pressure and/or the output fluid flow rate.

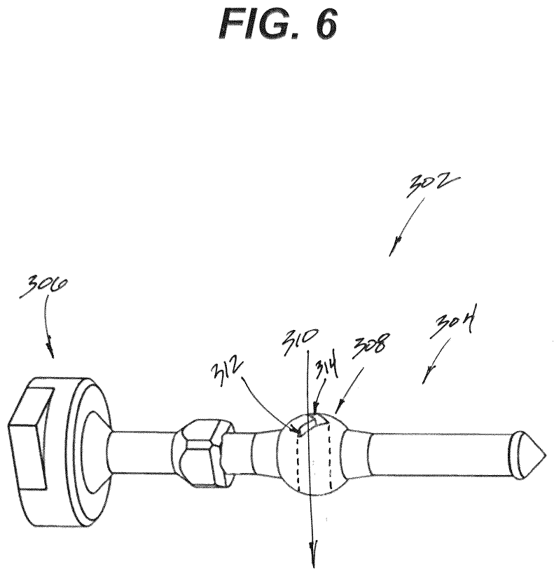

In some embodiments, as shown in FIGS. 6-8, the valve assembly 300 includes a valve member 302 including a valve section 304 with a valve knob 306 at its distal end. The valve section 304 may be generally elongate and may include a valve interface member 308 including a fluid through hole 310.

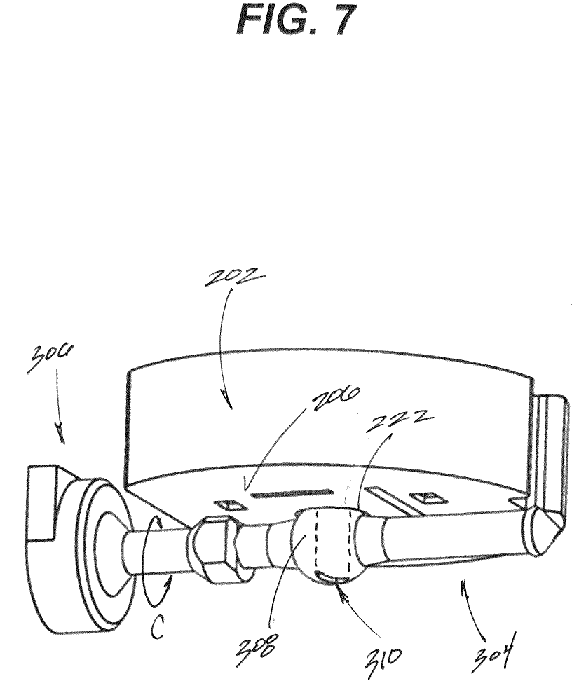

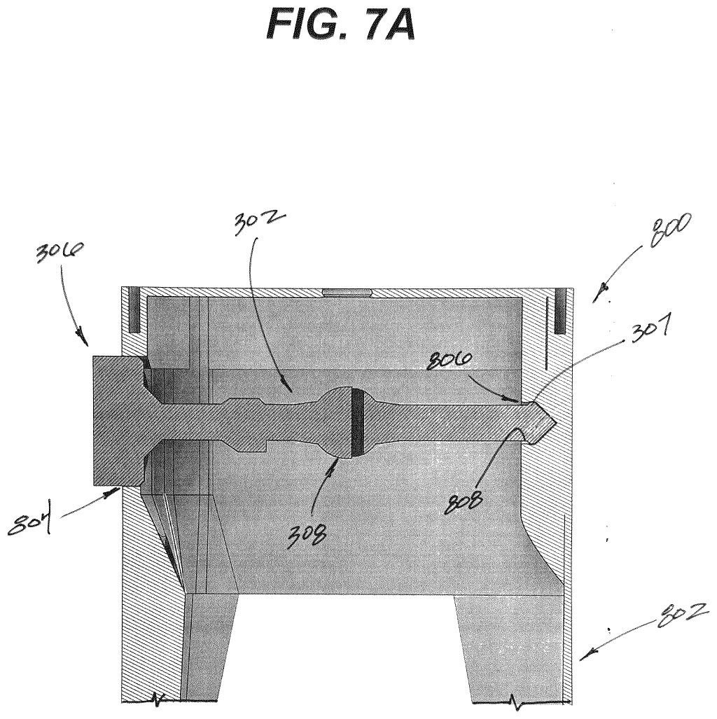

In some embodiments, as shown in FIG. 7, the valve member 302 may be configured beneath the constant flow tank 202 with the longitudinal axis of the valve member 302 running generally parallel to the bottom side 206 of the constant flow tank 202. As shown in FIG. 7A, the valve member 302 may be inserted through a first aperture 804 in the system's housing 800 to be placed in position. The proximal end of the valve member 302 may be received into a second aperture 806 in an inner wall of the housing 800 opposite the first aperture 804 and be held therein. The second aperture 806 may include a detent 808 that corresponds to a circumferential ridge 307 on the valve member's proximal end. When the proximal end is received into the second aperture 806, the circumferential ridge 307 may engage the detent 808 to releasably hold the valve member 302 in place. In this arrangement, the valve member's knob 306 may be nested in and supported by the first aperture 804 with at least a portion of the knob 306 available outside the housing 800 for grasping. As such, the knob 306 may be adjusted (as described in other sections) and the valve member 302 may be removed from the housing 800 (through the first aperture 804) using an outward force to overcome the detent 808.

In some embodiments, with the valve member 302 in this arrangement, the valve interface member 308 may abut against the tank's lower fluid port 222 and may direct the fluid flow from the fluid port 222 into the fluid path control assembly 400 as described in other sections.

In some embodiments, the valve interface member 308 may be spherical or semi-spherical in shape (e.g., a bulb) with a diameter slightly larger than the diameter of the lower fluid port 222 so that the interface member 308 may cover the entire cross section of the port 222. In some embodiments, the fluid through hole 310 passes through the valve interface member 308 from the top to the bottom such that fluid from the constant flow tank 202 may flow through the through hole 310 and into the fluid path control assembly 400 beneath.

In some embodiments, as best seen in FIG. 6, the fluid through hole 310 may include a cross section that includes a left side 312 and a right side 314. In addition, as shown in FIG. 7, the valve member 302 may be rotated about its longitudinal axis as depicted by the arrow C thereby varying the orientation of the through hole 310 with respect to the constant flow tank's lower fluid port 222. For example, the valve member 302 may be rotated to orient the through hole 310 such that all or most of its cross section may be aligned with the lower fluid port 222 such that a maximum amount of fluid may flow therethrough. In another example, the valve member 302 may be rotated (clockwise and/or counterclockwise) so that a lesser amount of the through hole's cross section may be aligned with the lower fluid port 222 resulting in a reduces flow rate of fluid through the port 222. In this case, a portion of the through hole's left side 312 or right side 314 may be positioned outside the path of the lower fluid port 222 such that the usable size of the through hole 310 is reduced thereby causing the flow rate also to be reduced proportionally.

In some embodiments, the valve member 302 may be rotated to an orientation that places the entire opening of the through hole 310 outside the path of the constant flow tanks lower fluid port 222 such that the valve assembly 300 is shut off. In this case, it may be preferable that no fluid is able to pass through the valve member 310 or the tank's lower fluid port 222.

Given the above, the flow rate out of the tank's lower fluid port 222 may be varied from a completely open position to a completely closed position (and to each and every incremental setting therebetween) by rotating the valve member 202. In some embodiments, a user may grasp the valve member's knob portion 306 to execute the valve member 302 rotation.

While the through hole 310 shown in FIG. 6 may be depicted as generally V-shaped, the through hole 310 may be formed as other suitable shapes or forms, e.g., straight, curved, S-shaped, etc.

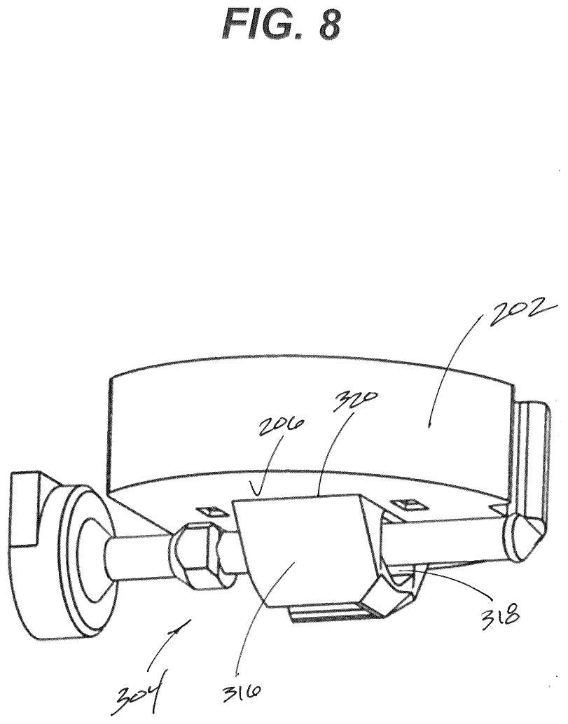

In some embodiments, as shown in FIG. 8, the valve member 302 is secured in position using a valve guard 316 including an aperture 318 into which the valve member 302 may be received and held, and an upper surface 320 that may be coupled to the bottom side 206 of the constant flow tank 202. The valve guard 316 also may facilitate the rotating of the valve member 202 within its aperture 318.

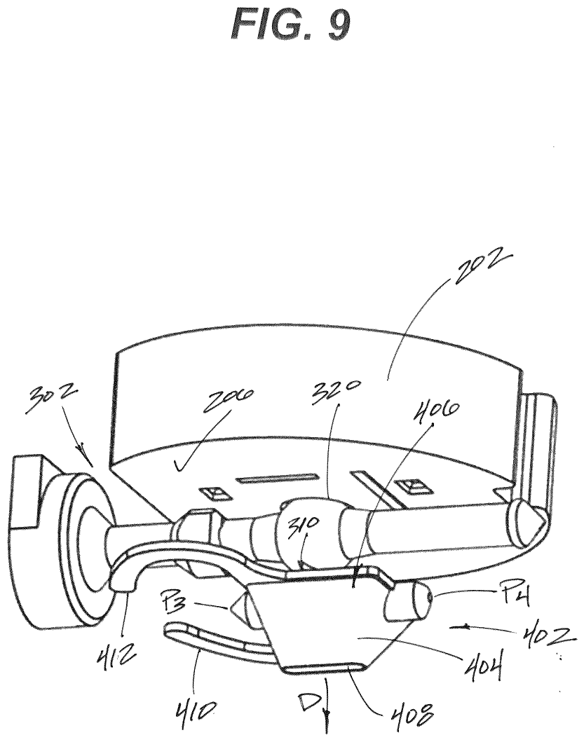

FIG. 9 shows a portion of the fluid path control assembly 400 configured beneath the valve assembly 300. The valve guard 316 has been omitted in this drawing for clarity.

In some embodiments, as shown in FIG. 9, the fluid path control assembly 400 includes a fluid director 402 including a hollow body 404 (e.g., a dish) including an upper input 406 and a lower output 408. The fluid director's input 406 may be configured beneath the valve member's through hole 310 and positioned to receive fluid flowing through the valve assembly 300. The fluid director 402 may then direct the fluid out its output 408 as depicted by the arrow D.

In some embodiments, the fluid director 402 is configured to controllably rotate about pivot points P3 and P4 thereby controllably moving the director's output 408 from side to side. As will be described in other sections, this side-to-side movement may determine the path that the fluid may take as it exits the fluid director 402 and enters into the fluid conduit assembly 500.

In some embodiments, the fluid director 402 includes a first handle 410 (e.g., on the left side) and a second handle 412 (e.g., on the right side). Controlled up or down movement of the first and/or second handle 410, 412 may cause the fluid director 402 to pivot about the pivot points P3, P4 accordingly. For example, if the first handle 410 is moved upward, the fluid director's output 408 may pivot to the left, and if the second handle 412 is moved upward, the fluid director's output 408 may pivot to the right. In some embodiments, the first and second handle 410, 412 may be formed as opposing C-shaped members.

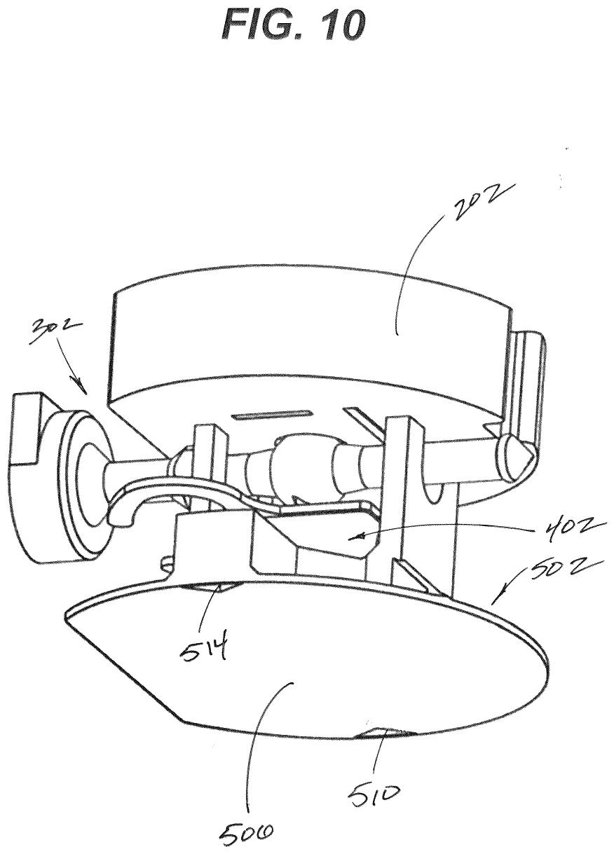

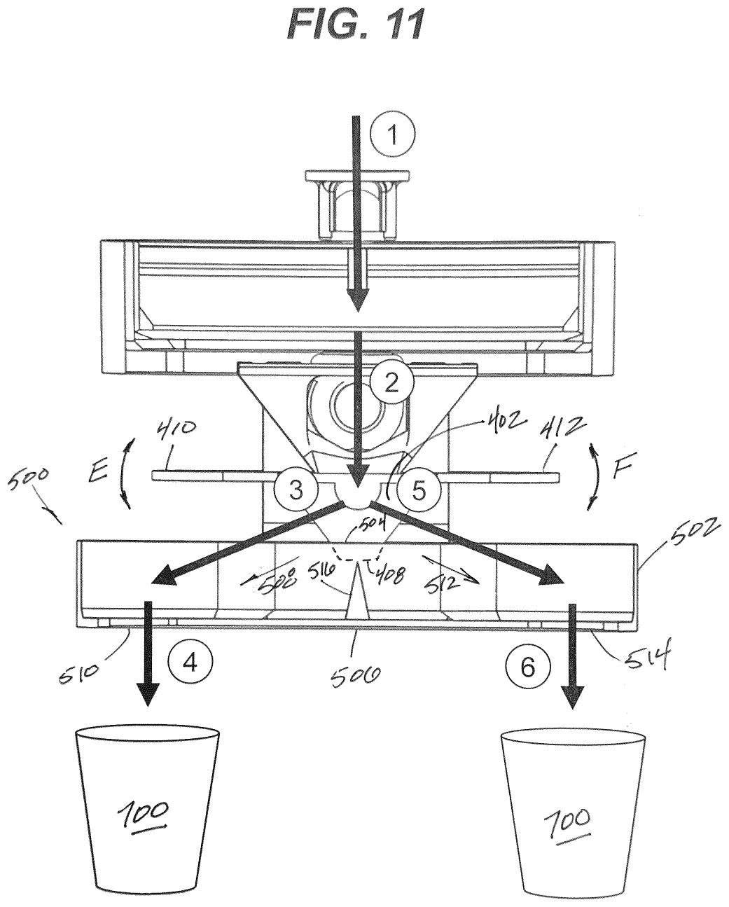

FIGS. 10 and 11 show the fluid conduit assembly 500 configured beneath the fluid director 402 and arranged to receive fluid flow from the director's output 408. FIG. 10 shows a perspective view and FIG. 11 shows a sectional view from the front of the assembly 10.

In some embodiments, as shown in FIGS. 10 and 11, the fluid conduit assembly 500 includes a fluid conduit body 502 with an upper input port 504 configured beneath the fluid director's lower output 408 and arranged to receive fluid flow therefrom. The conduit body 502 also may include a closed bottom 506 and a first fluid passageway 508 (e.g., to the left in FIG. 11) leading to a first output port 510 in the body's bottom 506 (e.g., on the left side), and a second fluid passageway 512 (e.g., to the right in FIG. 11) leading to a second output port 514 in the body's bottom 506 (e.g., on the right side). The conduit body 502 also may include a passageway divider or partition 516 separating the first and second passageways 508, 512 by disallowing fluid to pass between the two 508, 512.

In some embodiments, when the output 408 of the fluid director 402 is pivoted to the left (e.g., by moving the left handle 410 upward in the direction of the arrow E and/or by moving the right handle 412 downward in the direction of the arrow F), the fluid director 402 may generally point in the direction of the first fluid passageway 508 thereby causing the fluid to flow from the director 402 into the first passageway 508 and out the first output port 510. Conversely, when the output 408 of the fluid director 402 is pivoted to the right (e.g., by moving the left handle 410 downward in the direction of the arrow E and/or by moving the right handle 412 upward in the direction of the arrow F), the fluid director 402 may generally point in the direction of the second fluid passageway 512 thereby causing the fluid to flow from the director 402 into the second passageway 512 and out the second output port 514.

In some embodiments, a first cup 700 may be positioned beneath the first output port 510 to receive fluid flowing therefrom and a second cup 700 may be positioned beneath the second output port 514 to receive fluid flowing therefrom.

Given all of the above, as shown in FIG. 11, fluid may flow from the main reservoir tank 100 at (1) into the constant flow rate assembly 200. This first flow of fluid may be constant and/or not constant and may include a first fluid flow rate variation over a particular period of time. The fluid may then flow from the constant flow assembly 200 through the valve assembly at (2). This second flow of fluid may be constant or near constant may include a second flow rate variation over the same particular period of time that less than the first flow rate variation over the particular period of time of the first flow of fluid. The fluid may then flow into the fluid path control assembly 400, and depending on the setting of the fluid divider 402, may flow into the fluid conduit assembly's first fluid passageway 508 at (3), out the first output port 510 at (4) and into the first cup 700 (at a constant or near constant flow rate), or into the fluid conduit's second fluid passageway 512 at (5), out the second output port 514 at (6) and into the second cup 700 (at a constant or near constant flow rate).

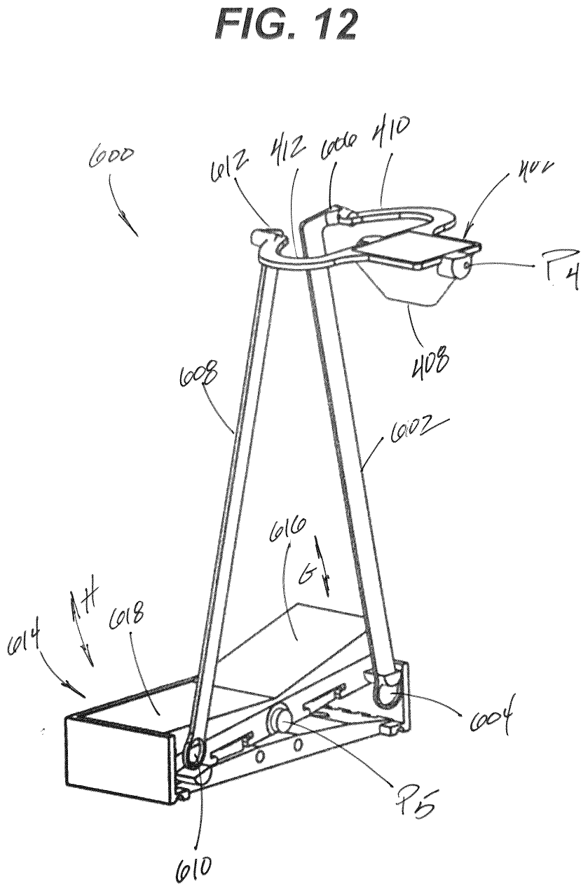

In some embodiments, as shown in FIG. 12, the control assembly 600 includes a first control arm 602 (e.g., a left control arm) including a first end 604 and a second end 606, and a second control arm 608 (e.g., a right control arm) including a first end 610 and a second end 612. The assembly 600 also may include control mechanism module 614 that may include a first control mechanism 616 (e.g., a first button) and a second control mechanism 618 (e.g., a second button).

In some embodiments, the first button 616 may be coupled to the second button 618, opposing one another) and the buttons 616, 618 may be configured to pivot up and down in the directions depicted by the arrows G and H, respectively. For example, when the first button 616 is pressed downward, the second button 618 may be caused to rotate upwards about the pivot point P5, and when the second button 618 is pressed downward, the first button 616 may be caused to rotate upwards about the pivot point P5.

In some embodiments, the first end 604 of the first control arm 602 is coupled to the first button 616 and the second end 606 of the arm 602 is coupled to the left handle 410 of the fluid director 402. Similarly, the first end 610 of the second control arm 608 is coupled to the second button 618 and the second end of the arm 608 is coupled to the right handle 412 of the fluid director 402.

Accordingly, as the first button 616 is pressed downward (causing the second button 618 to move upward), the downward motion of the button 616 may cause the first control arm 602 to also move downward thereby pulling downward on the fluid director's first handle 410. This in turn may cause the fluid director 402 to pivot to the right thereby causing fluid to flow into the conduit assembly's right passageway 512 and out the right output port 514 (and into a player's cup beneath). Then, when the second button 618 is pressed downward (causing the first button 616 to move upward), the downward motion of the button 618 may cause the second control arm 608 to also move downward thereby pulling downward on the fluid director's second handle 412. This in turn may cause the fluid director 402 o pivot to the left thereby causing fluid to flow into the conduit assembly's left passageway 508 and out the left output port 510 (and into a player's cup beneath).

It is appreciated that while the above description describes the fluid director 402 as controllable to direct the fluid into one of a total of two fluid passageways 508, 512 and then out of one of a total of two output ports 510, 514, respectively, the fluid director 402 may be configured to direct the fluid into other total numbers of fluid passageways and then out of other total numbers of output ports. For example, for three players, the fluid director 402 may be controllable to direct the fluid into one of a total of three fluid passages and then out of one of a total of three output ports. Other numbers of fluid passageways and output ports also may be included for other numbers of players.

In addition, for team play, the fluid director 402 may be configured to direct the fluid into passageways that may each lead to a plurality of output ports such that each team member's cup may receive the fluid in unison.

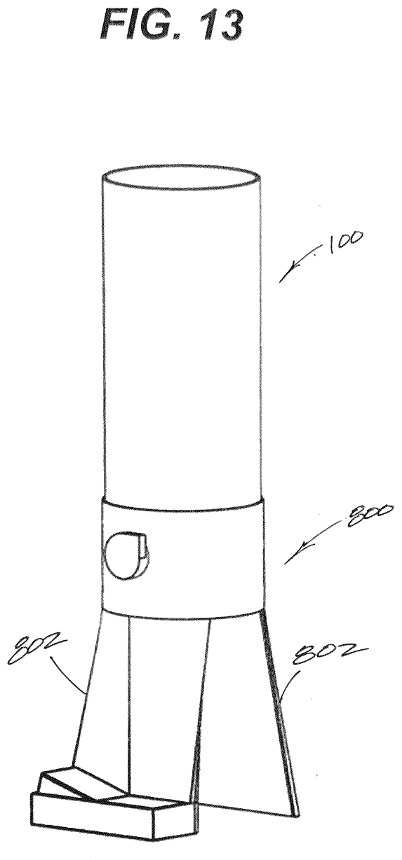

In some embodiments, as shown in FIG. 13, the system 10 may include a housing 800 designed to enclose, protect, and provide support to the other assemblies 100, 200, 300, 400, 500, 600, 700. The housing 800 also may include standing support members 802 enabling the system 10 to stand upright on a table or other game playing surface.

As described in relation to FIG. 7A in other sections, in some embodiments, the valve member 302 may be held between first and second apertures 804, 806 in the system's housing 800, and may be removed from the housing 800 through the first aperture 804 by pulling it outward. In addition, as shown in FIG. 8, the valve guard 316 includes an aperture 318 that receives the valve member 302 thereby connecting the valve guard 316 to the valve member 302. As such, removal of the valve member 302 also may release the valve guard 316. Furthermore, the assemblies 300, 400, and 500 may each be sequentially secured to one another generally below the valve member 302 such that all of the assemblies 300, 400, and 500 may be released and removed by first removing the valve member 302 from the housing 800. In this way, the assemblies 300, 400, 500 may be easily removed (e.g., for cleaning) and replaced again for further use.

In general, to begin a player's turn when using the system 10 during a turn-based game, the first button 616 may be pressed down and the valve member 302 may be rotated to start the flow of fluid out of the constant flow tank 202. With the first button 616 set in the down position, the fluid may flow into a player's cup 700 on the right. The fluid may continue to flow and the cup 700 on the right may continue to fill until the player finishes his/her turn and presses the second button 618 down. This may stop the flow into his/her cup 700 and may begin the flow into an opposing player's cup 700, e.g., a cup 700 on the left side. During the opposing player's turn, the first player may be required to drink the amount of fluid (e.g., beer) that flowed into his/her cup 700. Then, when the opposing player completes his/her turn, he/she may press the second button 618 downward thereby stopping the fluid flow into his/her cup 700, and starting the flow back into the first player's cup 700 during the first player's ensuring turn. This process may continue until a stopping point such as the end of the game.

It is understood that any aspect or element of any embodiment of the system 10 described herein may be combined with any other aspect or element of any other embodiment of the system 10 to form additional embodiments of the system 10, all of which are within the scope of the system 10.

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A fluid-based game timer system for use with a turn-based game, the fluid-based game timer system comprising:
a reservoir configured to hold a volume of fluid and including a first fluid output port;
at least one fluid passageway in fluid communication with the first fluid output port and including a second fluid output port;
a control mechanism configured to regulate a first flow of at least a portion of the first volume of fluid from the reservoir and out the second fluid output port;
wherein the first flow is used to provide an indication of a length of a first single turn of the turn-based game.

2. The fluid-based game timer system of claim 1 wherein the first flow includes a first flow rate variation over a first period of time out of the first fluid output port and a second flow rate variation over the first period of time out of the second fluid output port, the fluid-based game timer system further comprising:
a flow rate regulating mechanism configured to cause the second flow rate variation to be less than the first flow rate variation.

3. The fluid-based game timer of claim 2 wherein the flow rate regulating mechanism includes a constant flow tank configured to receive fluid from the reservoir through the first output port and including a third fluid output port and a floater mechanism configured to follow a surface level of the fluid within the constant flow tank and to open the first fluid output port when the surface level of the fluid within the constant flow tank is at a predetermined level;

4. A fluid-based game timer system for use with a turn-based game, the fluid-based game timer system comprising:
a reservoir configured to hold a volume of fluid and including a first fluid output port;
a constant flow tank configured to receive a first fluid flow from the reservoir through the first fluid output port, the first fluid flow including a first flow rate variation over a first period of time, and to deliver a second fluid flow to at least one fluid passageway, the second fluid flow including a second flow rate variation over the first period of time, wherein the second flow rate variation is less than the first flow rate variation;
a fluid director mechanism controllable to direct the second fluid flow from the at least one fluid passageway to at least one second fluid output port.

5. The fluid-based game timer system of claim 4 further comprising:
a control mechanism configured to control the fluid director mechanism to direct the second fluid flow to a first at least one second fluid output port or to a second at least one second fluid output port.

6. A fluid-based game timer system of claim 4 wherein the constant flow tank includes a floater mechanism configured to follow a surface level of fluid within the constant flow tank and to deliver the second fluid flow to the at least one fluid passageway when the surface level of the fluid within the constant flow tank is at a predetermined level.

7. A fluid-based game timer system for use with a turn-based game, the fluid-based game timer system comprising:
a reservoir configured to hold a volume of fluid and including a first fluid output port;
a constant flow tank configured to receive fluid from the reservoir through the first output port and including a second fluid output port and a floater mechanism configured to follow a surface level of the fluid within the constant flow tank and to open the first fluid output port when the surface level of the fluid within the constant flow tank is at a predetermined level;
a fluid director mechanism controllable to direct a flow of the fluid out of the second output port to at least a first fluid passageway or a second fluid passageway; and
a control mechanism configured to control the fluid director mechanism to direct the fluid to the first fluid passageway and/or to the second fluid passageway.

8. The fluid-based game timer system of claim 7 further comprising:
a valve assembly configured to regulate the flow of the fluid out of the second output port.

9. The fluid-based game timer system of claim 8 wherein the valve assembly includes a valve member with a valve aperture that when rotated regulates the flow of the fluid out of the second output port and through the valve aperture.

10. The fluid-based game timer system of claim 7 wherein the first fluid output port includes a ball member configured to releasably seal the first fluid output port, and the floater mechanism is configured to dislodge the ball member from the first fluid output port when the surface level of the fluid within the constant flow tank is at a predetermined level.

11. The fluid-based game timer of claim 10 wherein the floater mechanism includes a floater portion adapted to follow the surface level of the fluid and a displacement tab configured to engage the ball member.

12. The fluid-based game timer of claim 11 wherein the floater mechanism is configured to pivot about a first pivot point such that as the surface level of the fluid drops the displacement tab moves to displace the ball member.

13. The fluid-based game timer of claim 7 wherein the fluid directing mechanism includes a dish configured to receive the flow of the fluid out of the second output port, the dish configured to pivot about a second pivot point.

14. The fluid-based game timer of claim 13 wherein the dish is configured to pivot to a first position that directs the fluid to the first fluid passageway and/or to a second position that directs the fluid to the second fluid passageway.

15. The fluid-based game timer of claim 14 wherein the control mechanism is configured to cause the dish to pivot to the first position and/or to the second position.

16. The fluid-based game timer of claim 15 wherein the control mechanism includes a first control member configured to cause the dish to pivot to the first position and a second control member configured to cause the dish to pivot to the second position.

17. The fluid-based game timer of claim 16 wherein the first control member includes a first rod with a first rod proximal end configured with a first control activation member and a first rod distal end configured with a first side of the dish, and the control member includes a second rod including a second rod proximal end configured with a second control activation member and a second rod distal end configured with a second side of the dish.

18. The fluid-based game timer of claim 17 wherein the first control activation member includes a first button configured to cause a first movement of the first rod, and the second control activation member includes a second button configured to cause a second movement of the second rod.

19. The fluid-based game timer of claim 7 wherein the first fluid passageway leads the fluid to a first system fluid output port and/or the second fluid passageway leads the fluid to a second system fluid output port.

20. The fluid-based game timer of claim 7 wherein when the first fluid output port is open the fluid flows through the first fluid output port at a first flow rate with a first flow rate variation over a first period of time, and the fluid flows through the second fluid output port at a second flow rate with a second flow rate variation over the first period of time, and wherein the second flow rate variation is less than the first flow rate variation.
